(19) United States
(12) Patent Application Publication
(10) Pub. No.: US 2007/0048466 A1
(43) Pub. Date: Mar. 1, 2007

(54) Thermal transfer image receiving sheet and method

(76) Inventor: Dieu Dai Huynh, Courcouronnes (FR)

Correspondence Address: Heidi A. Boehlefeld;Renner, Otto, Boisselle & Sklar, LLP, Nineteenth Floor, 1621 Euclid Avenue, Cleveland, OH, 44115, US

(21) Appl. No.: 11/217,552

(22) Filed: Sep. 1, 2005

(51) Int. Cl. B41M 5/40

(52) U.S. Cl. 428/32.6

(57) ABSTRACT

A thermal transfer image-receiving polymeric sheet capable of recording thereon thermally transferred dye or ink images in a clear and sharp form. The image-receiving layer comprises at least one water dispersible aliphatic polyether-polyurethane resin and a silica dispersion.

### FIELD OF THE INVENTION

The present invention relates to a thermal transfer image-receiving sheet. More particularly, the present invention relates to a matte finish thermal transfer image-receiving polymeric sheet capable of recording thereon thermally transferred dye or ink images in a clear and sharp form.

### BACKGROUND

In thermal transfer recording systems an ink ribbon is heated through a thermal head or by laser or the like in accordance with image information. The heating causes thermal melting, thermal diffusion or sublimation, by which a dye is transferred from the ink ribbon onto a printing sheet to form an image on the printing sheet.

The printing sheet generally is made up of a support film having a dye receiving layer coated thereon. The dye receiving layer is a layer that receives a dye or ink transferred thereto from the ink ribbon by heating and preserves an image formed from the dye. Typical dye receiving layers for polymeric substrates comprise at least one dye receptive resin dissolved in an organic solvent. Examples of such solvent borne resins include polyester, polycarbonate, polyvinyl chloride, vinyl chloride copolymers such as vinyl chloride-vinyl acetate copolymer, and thermoplastic resins such as polyurethane resin, polystyrene, acrylic-styrene (AS) resin, acrylonitrile-butadiene-styrene (ABS) resin, and the like.

It may be desirable to reduce or eliminate the use of volatile organic solvents in the process for manufacturing polymeric image receiving sheets. In particular, it may be desirable to employ an aqueous composition for producing an image receiving layer on a polyester substrate without compromising image clarity and durability.

### SUMMARY

According to one aspect of the invention, a printing sheet of the type that is used in a thermal transfer recording system is provided. The printing sheet comprises a polymeric film support, and a matte finish image receiving layer formed on the film support. The image receiving layer may be formed from a coating of an aqueous coating composition. In one embodiment, the aqueous coating composition comprises an aqueous dispersion of an aliphatic polyether-polyurethane and a silica dispersion. An aqueous crosslinking agent may be added to the aqueous coating composition.

According to another aspect of the invention, a dye receiving coating composition is provided. In one embodiment, the dye receiving coating composition comprises an aqueous dispersion of an aliphatic polyether-polyurethane resin and a silica dispersion.

According to yet another aspect of the invention, a method of preparing a matte finish thermal transfer image receiving sheet is provided. The method provides for coating a substrate sheet surface with the aqueous coating composition.

### BRIEF DESCRIPTION OF THE DRAWINGS

In the accompanying drawings:

FIG. 1 is a schematic view illustrating a cross-section of a thermal transfer image receiving sheet according to the present invention.

### DETAILED DESCRIPTION

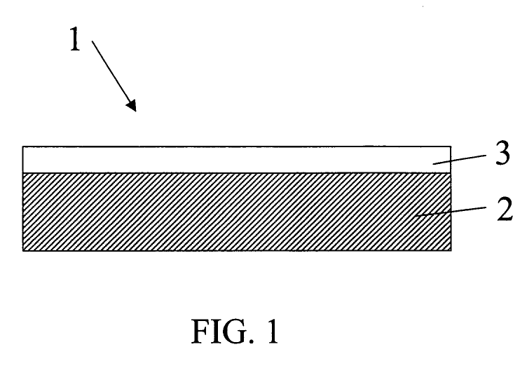

A first embodiment of the thermal transfer image receiving sheet of present invention may be described in reference to FIG. 1. FIG. 1 is a schematic view of a cross section of one example of a thermal transfer image receiving sheet 1 that includes substrate sheet 2 and a dye receiving layer 3 disposed on one surface of the substrate sheet 2.

The substrate sheet 2 may be formed from sheet materials selected with reference to application specific criteria. Such criteria may include, for example, desired dimensions (height, length and thickness), surface texture, composition, flexibility, and other physical and economic attributes or properties. Suitable sheet materials may include, for example, synthetic papers such as polyolefin type, polystyrene type; wood free paper; art paper; coat paper; cast coat paper; wall paper; lining paper; cellulose fiber paper such as paperboard; various plastic films or sheets such as polyolefin, polyvinyl chloride, polyethylene terephthalate, polystyrene, polymethacrylate and polycarbonate.

In one embodiment, the substrate sheet 2 may be, or may include, a multilayer polymeric sheet. The multi-layers may be coextruded, or the multi-layers may be laminated together. In one embodiment, the substrate sheet 2 includes both co-extruded multi-layers and laminated multi-layers.

In addition, a white opaque film may be formed by adding a white pigment to one or more of the aforementioned synthetic resins and used as the substrate sheet 2. In one embodiment, a foamed film is used as the substrate sheet 2. The foamed film may be formed by a conventional foaming operation. In one embodiment, the substrate sheet 2 may be a laminated body formed by combining a plurality of single-layered sheets composed of the above listed materials. Examples of such a laminated body may include the combination of cellulose fiber paper with synthetic paper, and a laminated body of combined cellulose fiber paper with a plastic film or sheet.

The thickness of the substrate sheet 2, formed in the manner as mentioned above, may be determined with reference to application specific criteria. Such criteria may include the desired end use. In one embodiment, the sheet thickness is in a range of from about 10 microns or micrometers (μm) to about 300 μm. In one embodiment, the sheet thickness is in a range of from about 20 micrometers or microns (μm) to about 200 μm. In one embodiment, the sheet thickness is in a range of from about 30 micrometers or microns (μm) to about 150 μm.

A primer treatment or a corona discharging treatment may be used on the substrate sheet 2 to increase a bonding strength between the substrate sheet 2 and the dye receptor layer 3 to be formed on a surface of the substrate sheet 2.

An intermediate layer (not shown) may be provided between the dye receptor layer 3 and the substrate sheet 2 to impart preselected properties. Such properties may include an adhesion property, whiteness or brightness, cushioning property, antistatic property, shielding property, anti-curling property, and the like.

A back surface layer (not shown) may be provided onto a surface opposite the surface of the substrate sheet 2 to which the dye receiving layer 3 is formed. The back surface layer may impart preselected properties to the thermal transfer image receiving sheet 1. The properties may include, for example, an enhanced conveying fitness, an enhanced writing property, pollution resistance, anti-curling property, and the like. If desired, an antistatic layer (not shown) containing a commercially available antistatic agent may be provided on the dye receiving layer 2 or the back surface layer to improve the antistatic property of the thermal transfer image receiving sheet 1.

The dye receiving layer 2 comprises a coating formed from an aqueous composition. In one embodiment, the aqueous coating composition includes at least one water dispersible aliphatic polyether-polyurethane resin and a silica dispersion. The dispersion may comprise colloidally dispersed particles of the polyurethane polymers.

In one embodiment, the polyether-polyurethane polymer is the reaction product of a predominantly aliphatic polyisocyanate component and a polyether polyol component. As used herein, the term “predominantly aliphatic” means that at least 70 weight percent of the polyisocyanate component is an aliphatic polyisocyanate, in which all of the isocyanate groups are directly bonded to aliphatic or cycloaliphatic groups, irrespective of whether aromatic groups are also present. More preferably, the amount of aliphatic polyisocyanate is at least 85 weight %, and most preferably, 100 weight %, of the polyisocyanate component. Examples of suitable aliphatic polyisocyanates include ethylene diisocyanate, 1,6-hexamethylene diisocyanate, isophorone diisocyanate, cyclohexane-1,4-diisocyanate, 4,4′-dicyclohexylmethane diisocyanate, cyclopentylene diisocyanate, p-tetra-methylxylene diisocyanate (p-TMXDI) and its meta isomer (m-TMXDI), hydrogenated 2,4-toluene diisocyanate, and 1-isocyanto-1-methyl-3(4)-isocyanatomethyl cyclohexane (IMCI). Mixtures of aliphatic polyisocyanates can be used. Suitable polyether polyols include products obtained by the polymerization of a cyclic oxide or by the addition of one or more such oxides to polyfunctional initiators. Such polymerized cyclic oxides include, for example, ethylene oxide, propylene oxide and tetrahydrofuran. Such polyfunctional initiators having oxides added include, for example, water, ethylene glycol, propylene glycol, diethylene glycol, cyclohexane dimethanol, glycerol, trimethylopropane, pentaerythritol and Bisphenols (such as A and F).

Commercially available polyether-polyurethanes useful in the present invention include those sold under the trade names SANCURE 878, AVALURE UR-450 and SANCURE 861 by Goodrich Corporation (Charlotte, N.C.), and NEOREZ R-551 and NEOREZ R-563 by NeoResins (Waalwijk, The Netherlands).

The dye receiving layer 3 may include a water dispersible crosslinker. Suitable water-dispersible polyfunctional chemically activatable crosslinking agents are commercially available. These crosslinking agents include dispersible formulations of polyfunctional aziridines, isocyanates, melamine resins, epoxies, oxazolines, carbodiimides and other polyfunctional crosslinkers. In one embodiment, the crosslinking agents are added at an amount in a range of from about 0.1 parts to about 10 parts based on 100 parts total solids. In one embodiment, the crosslinking agents are added at an amount in a range of from about 0.2 parts to about 5 parts based on 100 parts total solids. Adding crosslinking agents to the polyurethane dispersion composition may form an interpenetrating or interconnected network having crosslinked matrixes is formed which link the blended polymers with covalent and/or non-covalent linkages.

A matting agent useful in the composition comprises silica dispersion. In one embodiment, silica particles in an amount of from about 2.0% to about 15% (solids) by weight are added to the composition. In one embodiment, silica particles in an amount of from about 4% to about 8% (solids) by weight are added to the composition. The silica is typically added as an aqueous dispersion. Useful commercially available silica matting agents include the SYLOID® C-Series silica gel matting agents from W. R. Grace.

Pigments may be added to the composition to increase the opacity and/or modify the porosity of the coated substrate. In one embodiment, white pigment is added to the coating composition. Other additives such as waxes, defoamers, antioxidants, UV stabilizers, etc. may be included in the composition to obtain a certain desired characteristic.

A thermal transfer image-receptive coated product can be made by applying a thermal transfer image-receptive composition as described above to one or both surfaces of a face stock or label stock using conventional coating or other application technique. Non-limiting examples of such techniques include slot die, air knife, brush, curtain, blade, floating knife, gravure, kiss roll, knife-over-blanket, knife-over-roll, off set gravure, reverse roll, reverse-smoothing roll, rod, and squeeze roll coating.

In general, dry coat weight of the coated composition is greater than about 1.0 g/m². In one embodiment, the dry coat weight of the image receiving layer is in the range of from about 1.1 g/m² to about 10 g/m², or about 2 g/m² to about 5 g/m².

### EXAMPLE

The following example is intended only to illustrate methods and embodiments in accordance with the invention, and as such should not be construed as imposing limitations upon the claims.

### Example 1

A coating composition comprising the ingredients listed in Table 1 is prepared as follows:

| Ingredient | Wt. % |
|---|---|
| Polyurethane dispersion NEOREZ R-563: aliphatic | 18.6 |
| polyether urethane dispersion, 35, .5% solids) | |
| Silica SYLOID C 503 (100% solids) | 6.5 |
| White pigment | 9.3 |
| Water | 65.3 |
| Crosslinker CX-100: polyfunctional aziridine crosslinker | 0.2 |

The coating composition is coated onto a 2 mil polyethylene terephthalate (PET) substrate web. The coating is dried at a temperature of about 90° C. and a line speed of about 120 meters/minute to form an image receiving layer. The dry coat weight of the image receiving layer is about 2.5 g/m².

The coating composition of Example 1 is also coated onto a matte chrome, biaxially oriented PET substrate having a thickness of about 2 mils, and onto a white, biaxially oriented PET substrate having a thickness of about 2 mils.

While the invention has been explained in relation to embodiments, it is to be understood that various modifications thereof will become apparent to those skilled in the art upon reading the specification. Therefore, it is to be understood that the invention disclosed herein is intended to cover such modifications as fall within the scope of the appended claims, and to cover insubstantial variations thereof.

What is claimed is:

1. A thermal transfer image receiving sheet comprising:
a substrate sheet; and
an image receiving resinous layer on at least one surface of the substrate sheet, the image receiving resinous layer having a dry coat weight greater than about 1 g/m² and comprising a dye receiving resinous material;
wherein the dye receiving resinous material comprises (a) at least one water dispersible aliphatic polyether-polyurethane and (b) water dispersible silica particles in an amount of about 2% to about 15% by weight.

2. The thermal transfer image receiving sheet of claim 1 wherein the substrate sheet comprises polyester.

3. The thermal transfer image receiving sheet of claim 2 wherein the substrate sheet comprises polyethylene terephthalate.

4. The thermal transfer image receiving sheet of claim 1 wherein polyether-polyurethane resin (a) comprises the reaction product of an aliphatic polyisocyanate component and a polyether polyol component.

5. The thermal transfer image receiving sheet of claim 1 wherein the image receiving resinous layer has a dry coat weight of about 1.1 g/m² to about 10 g/m².

6. The thermal transfer image receiving sheet of claim 1 wherein the image receiving resinous layer has a matte finish.

7. A dye receiving coating composition comprising:
(a) at least one aqueous dispersion of an aliphatic polyether-polyurethane resin; and
(b) water dispersible silica particles in an amount of about 2% to about 15% by weight.

8. The dye receiving coating composition of claim 7 further comprising a multifunctional crosslinking agent.

9. The dye receiving coating composition of claim 8 where the multifunctional crosslinking agent comprises a polyfunctional aziridine.

10. The dye receiving coating composition of claim 7 wherein the coating composition is substantially organic solvent free.

11. The dye receiving coating composition of claim 7 wherein dispersion (a) comprises the reaction product of an aliphatic polyisocyanate component and a polyether polyol component.

12. A method of forming a thermal transfer image receiving sheet having a matte finish comprising:
coating a substrate sheet surface with an aqueous coating composition, the aqueous coating composition comprising at least one water dispersible aliphatic polyether-polyurethane resin, a water dispersible silica, and an aqueous crosslinking agent;
drying the aqueous coating composition to form a thermal transfer image receiving sheet having a dry coat weight of greater than about 1 g/m and having a matte finish.
